(19) United States
(12) Patent Application Publication
(10) Pub. No.: US 2020/0047189 A1
(43) Pub. Date: Feb. 13, 2020

(54) APPARATUS AND METHOD FOR REMOVING MAGNETIC PARTICLES FROM LIQUIDS AND SLURRIES

(71) Applicant: Romar International Limited, Aberdeenshire (GB)

(72) Inventors: Malcolm Mackenzie, Aberdeenshire (GB); Robert Stables, Aberdeenshire (GB)

(21) Appl. No.: 16/338,938

(22) PCT Filed: Oct. 5, 2017
(86) PCT No.: PCT/GB2017/053023

§ 371 Date: Apr. 2, 2019

(30) Foreign Application Priority Data
Oct. 5, 2016 (GB) 1616947.6

(51) Int. Cl. B03C 1/28; E21B 21/06; E21B 41/00

(52) U.S. Cl. CPC B03C 1/286; B03C 1/284; B03C 2201/18; E21B 41/00; E21B 21/065

(57) ABSTRACT

The invention provides an apparatus for removing ferrous particles from metal contaminated oil and gas process liquids or slurries and method of use. The magnetic separator apparatus comprises a vessel with an inlet and an outlet configured to allow the flow through of a liquid or slurry, or to hold a liquid or slurry inside. A plurality of magnetic rod devices is mounted upon at least one frame member secured to the vessel such that they extend into the interior of the vessel. Each magnetic rod device has a first condition in which it is operable to attract ferrous particles, and a second condition in which it is operable to dispose of ferrous particles. Embodiments of the invention provide a magnetic separator apparatus for removing ferrous particles from contaminated liquids and slurries which are stored in a storage facility.

The present invention relates to an apparatus for removing ferrous particles from contaminated liquids and slurries, and a method of use of such apparatus. The invention has particular (although not exclusive) application to the removal of fine and ultra-fine ferrous particles from a liquid or slurry which has been used in a hydrocarbon production or transportation operation and which has been subject to a cutting, milling, grinding or drilling process, or similar. In particular, the invention in one of its aspects relates to an apparatus for and method of for removing ferrous particles from contaminated liquids and slurries which are stored in a storage facility.

### BACKGROUND TO THE INVENTION

In the oil and gas exploration and production industry, it is common to cut, mill, grind or drill through metal components. During such processes, fluid (commonly known as cutting, drilling or milling fluid) is used to lubricate and cool the cutting surfaces. This fluid is also often used to transfer the material removed by the cutting, milling, grinding or drilling process (sometimes referred to as cuttings) away from the cutting area to avoid clogging or damage to the tool. Therefore, it is common practice to circulate, process and re-circulate this fluid during such operations. The processing step typically aims to remove the bulk of the material from the fluid before it is reused.

It is known to treat fluid, such as drilling mud, in a fluid ditch using magnetic fields to separate the bulk of the metal material, known as swarf, from the fluid before it is re-used. Such operations are typically large scale (i.e. they handle large volumes of fluid at substantial flow rates) and, ultimately, are not able to definitively remove all fine and ultra-fine metal material from the fluid.

It is less known that various other fluids from oil and gas processes can also become contaminated with metal particles. As such, these other fluids are not typically processed in such a manner as described above to remove metal contaminants. Therefore, the use, or re-use, of such fluids can lead to tool, machinery and equipment failure.

It is also common to store fluid from an oil or gas operation in storage vessels or tanks, in-between uses or after use and before disposal. During storage, any contaminants which are present in the fluid (such as metal particles) will settle towards the bottom of the vessel or tank under the influence of gravity, such that when the fluid is first discharged from the tank after a length of time in storage, it is likely to contain concentrated areas or streams of contaminants. This may be the case even when the fluid has been processed previously, using a large-scale known method of metal particle removal, as discussed above.

### SUMMARY OF THE INVENTION

There is generally a need for a method and/or apparatus for removing fine and ultra-fine ferrous particles from metal contaminated oil and gas process liquids or slurries which addresses one or more of the drawbacks of known methods and/or apparatus.

It is amongst the aims and objects of the invention to provide a method and/or apparatus for removing fine and ultra-fine ferrous particles from metal contaminated oil and gas process liquids or slurries and which obviates or mitigates one or more drawbacks or disadvantages of known methods and/or apparatus.

Other aims and objects of the invention include providing an apparatus arranged as an independent, stand-alone unit, and method of use, which can be permanently integrated or temporarily plumbed into a facility which handles metal contaminated liquids or slurries.

A further aim of at least one aspect or embodiment of the invention is to provide an apparatus arranged as an independent, stand-alone unit, which is portable and can be re-used, in various applications and in conjunction with different systems and facilities, multiple times.

A further aim of at least one aspect or embodiment of the invention is to provide an apparatus arranged as an independent, stand-alone unit, which is suitable for use in a system which does not have a fluid ditch, open flowline or location suitable for a typical magnetic separating apparatus to be installed.

Further aims and aspects of the invention will become apparent from the following description.

According to a first aspect of the invention, there is provided a method for removing ferrous particles from a liquid or slurry, the method comprising:

providing an apparatus comprising:
a vessel comprising an inlet and an outlet;
at least one frame member secured to the vessel; and
a plurality of magnetic rod devices mounted upon the at least one frame member such that they extend into the interior of the vessel, each magnetic rod device comprising an elongate casing, an elongate magnet assembly retractably mounted within said casing and an external removal means;

exposing the magnetic rod devices to a liquid or slurry contaminated with metal particles while the plurality of magnetic rod devices are in a first condition such that the magnet assembly is positioned substantially below the removal means;

attracting metal particles to the casings of the plurality of magnetic rod devices;

removing at least one of the plurality of magnetic rod devices from the vessel; and

discharging magnetic particles from the at least one of the plurality of magnetic rod devices while it is in a second condition such that the magnet assembly is positioned substantially above the removal means.

The method may comprise permanently integrating and plumbing the apparatus into a system. Alternatively, the method may comprise temporarily integrating and plumbing the apparatus into a system. The method may comprise integrating and plumbing the apparatus, either permanently or temporarily, into a system which does not comprise a fluid ditch, open flowline or otherwise.

The method may comprise fluidly coupling the inlet and/or the outlet of the vessel to a flowline, pipeline and/or storage tank, a plurality of flowlines, pipelines and/or storage tanks or a combination thereof.

The method may comprise continuously or intermittently flowing a contaminated liquid or slurry through the vessel. Alternatively, or in addition, the method may comprise holding a body of substantially stationary contaminated liquid or slurry inside the vessel. Where the method comprises holding a body of liquid or slurry inside the vessel, the inlet and/or the outlet of the vessel may be provided with valves, and the method may comprise operating the valves to permit the filling and/or the emptying of the vessel.

A fixed handle may be mounted transversely to the external surface of the elongate casing of each of the plurality of magnetic rod devices. The fixed handle may facilitate the lifting and transportation of each of each of the plurality of magnetic rod devices. The method may comprise removing the at least one of the plurality of magnetic rod devices from the vessel by lifting it off of the at least one frame member using the fixed handle.

The method may comprise transporting the least one of the plurality of magnetic rod devices to a discharge location.

A bar or a rod may be attached to the upper end of the elongate magnet assembly of each of the plurality of magnetic rod devices. A handling means, such as a handle or a knob, may be provided at the top of said bar or rod. The magnet assembly may be moved up and down within the casing by operation of the handle or knob.

The removal means may be secured to the outer surface of the elongate casing of each of the plurality of magnetic rod devices at an axial height similar to that of the elongate magnet assembly when in its first condition. The removal means may be operable to act as a stopper to stop ferrous particles attracted to the outer surface of the casing from moving above it when the each of the plurality of magnetic rod devices is in a second condition. Therefore, the removal means may be operable to remove said ferrous particles attracted to the outer surface of the casing from the influence of the magnetic field produced by the magnet assembly such that ferrous particles may simply drop off of a magnetic rod device.

The method may comprise discharging particles from the least one of the plurality of magnetic rod devices at the discharge location by operating the handling means such that the magnet assembly is moved up within the casing towards its second condition above the removal means.

The method may comprise replacing the least one of the plurality of magnetic rod devices in the vessel after magnetic particles have been discharged from it.

According to a second aspect of the invention, there is provided an apparatus for removing ferrous particles from a liquid or slurry, the apparatus comprising:

a vessel comprising an inlet and an outlet;

at least one frame member secured to the vessel; and

a plurality of magnetic rod devices, each magnetic rod device comprising:
an elongate casing;
an elongate magnet assembly retractably mounted within said casing; and
a removal means on the exterior surface of the casing;

wherein each magnetic rod device has a first condition in which the elongate magnet assembly is positioned substantially below the removal means, and a second condition in which the elongate magnet assembly is positioned substantially above the removal means; and wherein the plurality of magnetic rod devices are mounted upon the at least one frame member such that they extend into the interior of the vessel.

The vessel may be operated to accommodate the continuous flow through of a liquid or slurry. Alternatively, or in addition, the vessel may be operated to hold a substantially stationary liquid or slurry inside. The inlet and/or the outlet of the vessel may be provided with at least one valve.

The inlet and/or the outlet of the vessel may be simple inlet and/or outlet ports. Preferably, the inlet and the outlet of the vessel are configured as standard flanged connections. In addition, the inlet and the outlet may be positioned anywhere on the vessel. Preferably, the inlet and the outlet may be positioned at different or opposite ends of the vessel. More preferably, the inlet may be positioned at a higher vertical location than the outlet. The outlet may be positioned close to the bottom of the vessel.

A baffle or a diffuser may be provided in the vessel. Preferably, a baffle plate may be provided proximate the inlet of the vessel. The baffle plate may be detachably secured to the vessel. The baffle plate may be operable to slow and/or diffuse the flow of liquid or slurry from the inlet evenly across the width of the vessel.

The vessel may be configured in various different shapes and sizes and constructed from various different materials, or a combination thereof. Preferably the vessel is substantially rectangular. The vessel may be provided with a lid. Preferably, where a lid is provided, the vessel and lid are secured to one another using knobs, to facilitate quick and easy removal. However, various other means of securing the vessel and the lid may be used.

The vessel may be provided with various external accessories and attachments to facilitate its transportation. The vessel may comprise lifting lugs and forklift pockets. The vessel may be provided with wheels.

The at least one frame member may be detachably secured to the vessel by securing means such as screws, bolts or magnets. Alternatively, the at least one frame member may be provided with a mounting means and/or a mounting surface to facilitate its mounting in or upon the vessel. Alternatively, or in addition, the at least one frame member may be permanently secured to the vessel by means such as welding. Preferably, a plurality of frame members is provided. The plurality of frame members may comprise individual frame members. Alternatively, or in addition, the apparatus may comprise a plurality of frame members secured to one another to form one overall frame structure.

The elongate casing of each of the plurality of magnetic rod devices may comprise a substantially hollow cylinder, which may have its top face removed. Alternatively, the elongate casing of each of the plurality of magnetic rod devices may comprise a substantially hollow rectangular prism, which may have its top face removed.

A handle may be mounted transversely to the external surface of the elongate casing of each of the plurality of magnetic rod devices. The handle may facilitate the lifting and transportation of each of each of the plurality of magnetic rod devices.

The removal means may be provided in the form of a plate. Preferably the removal means may be provided in the form of an annular disc wherein the inner diameter surface of the annular disc may be secured concentrically to the outer surface of the elongate casing of each of the plurality of magnetic rod devices. Preferably the removal means may be secured to the outer surface of the of the elongate casing of each of the plurality of magnetic rod devices such that no space or voids may exist between the removal means and the casing. The removal means may be secured to the outer surface of the of the elongate casing of each of the plurality of magnetic rod devices at an axial height similar to that of the elongate magnet assembly when in its first condition. The removal means may be operable to act as a stopper to stop ferrous particles attracted to the outer surface of the casing from moving above it when the each of the plurality of magnetic rod devices is in a second condition in which the elongate magnet assembly is positioned substantially above the removal means. Therefore, the removal plate of each of the plurality of magnetic rod devices may be operable to remove said ferrous particles attracted to the outer surface of the casing from the influence of the magnetic field produced by magnet assembly such that ferrous particles may simply drop off of the magnetic rod device.

The elongate magnet assembly of each of the plurality of magnetic rod devices may comprise a number of magnets, which may be smaller than the magnetic rod devices, and which may be assembled together to form a magnetic rod device. The poles of the magnets may be oriented transversally or axially with respect to the magnet assembly. The poles of the magnets may be oriented axially. The magnets may be arranged with like poles proximate to one another or repelling poles proximate to one another, or with a combination of like and repelling poles proximate to one another. Preferably, the magnets are arranged with repelling poles proximate to one another in the axial direction of the magnet assembly. The cross-section of the magnets may be substantially square, rectangular, circular or otherwise shaped. Preferably the magnets have a circular cross section such that the magnet assembly is substantially cylindrical or rod shaped. The outer diameter of the cylindrical or rod shaped magnet assembly of each of the plurality of magnetic rod devices may be slightly smaller than the inner diameter of the elongate casing such that it may slide concentrically in and out of the casing without excessive friction.

A bar or a rod may be attached to the upper end of the elongate magnet assembly of each of the plurality of magnetic rod devices. A handling means, such as a handle or a knob, may be provided at the top of said bar or rod. The magnet assembly may be moved up and down within the casing by operation of the handle or knob.

Each of the plurality of magnetic rod devices may be operable to attract ferrous particles to its casing when in its first condition and to discharge ferrous particles from its casing when in its second condition.

The at least one frame member may be configured to mount the plurality of magnetic rod devices. The at least one frame member may comprise a number of projections. Preferably, some or all of the projections of the at least one frame member may correspond to an attachment means which may be provided for each of the plurality of magnetic rod devices. Preferably, some or all of the projections of the at least one frame member may be square or rectangular. Preferably, some, or all of the square or rectangular projections of the at least one frame member may correspond to a square or rectangular aperture which may be defined by an attachment means which may be provided for each of the plurality of magnetic rod devices. Each of the plurality of magnetic rod devices may be slotted on to the at least one frame member.

Each of the plurality of magnetic rod devices may be provided with an attachment means. Preferably the attachment means facilitates the mounting of each of the plurality of magnetic rod devices on the at least one frame member. The attachment means may comprise two clamps which may each comprise two separable halves.

Preferably, when joined, the separable halves of one of the clamps may define a circular aperture therein which may be suitable in size to secure the elongate casing of a magnetic rod device. Each of the plurality of magnetic rod devices may be secured at different axial positions on their elongate casings such that when secured to the frame the extent to which each of the plurality of magnetic rod devices vertically extends into the interior of the vessel may differ.

Preferably, when joined, the separable halves of one of the clamps may define a square or rectangular aperture therein which may be suitable in size to slot on, or attach to, a projection on the at least one frame member. Preferably the two clamps may be secured to one another such that one of the clamps may secure a magnetic rod device and the other may attach to the at least one frame member, therefore securing a magnetic rod to the at least one frame member.

Embodiments of the second aspect of the invention may include one or more features of the first aspect of the invention or its embodiments, or vice versa.

According to a third aspect of the invention, there is provided a method for removing ferrous particles from a liquid or slurry from a storage facility, the method comprising:

providing an apparatus comprising:
a vessel comprising an inlet configured to be arranged in fluid communication with a first fluid storage vessel and an outlet configured to be arranged in fluid communication with a second fluid storage vessel; and
a plurality of magnetic devices operable to attract ferrous material;
wherein the first fluid storage vessel contains a liquid or slurry contaminated with metal particles;

flowing the liquid or slurry contaminated with metal particles from the first fluid storage vessel into the inlet of the apparatus;

attracting metal particles to the magnetic devices; and

flowing the clean liquid or slurry from the outlet of the apparatus into the second fluid storage vessel.

More than one fluid storage vessel may be arranged in fluid communication with either the inlet or the outlet of the vessel of the apparatus.

The apparatus may further comprise at least one frame member secured to the vessel and the plurality of magnetic devices may be mounted upon the at least one frame member such that they extend into the interior of the vessel. Each magnetic device may be configured as a magnetic rod device which may comprise a casing, a magnet assembly retractably mounted within said casing and an external removal means.

The method may comprise exposing the plurality magnetic rod devices of the apparatus to the liquid or slurry contaminated with metal particles while the plurality of magnetic rod devices are in a first condition such that the magnet assembly is positioned substantially below the removal means.

The method may comprise removing at least one of the plurality of magnetic devices from the vessel. Furthermore, the method may comprise discharging magnetic particles from the at least one of the plurality of magnetic devices while it is in a second condition such that the magnet assembly is positioned substantially above the removal means.

Embodiments of the third aspect of the invention may include one or more features of the first to second aspects of the invention or their embodiments, or vice versa.

According to a fourth aspect of the invention, there is provided an apparatus for removing ferrous particles from a liquid or slurry from a storage facility, the apparatus comprising: a vessel;

at least one frame member secured to the vessel; and

a plurality of magnetic rod devices, each magnetic rod device comprising:
an elongate casing;
an elongate magnet assembly retractably mounted within said casing; and
a removal means on the exterior surface of the casing;

wherein each magnetic rod device has a first condition in which the elongate magnet assembly is positioned substantially below the removal means, and a second condition in which the elongate magnet assembly is positioned substantially above the removal means; and wherein the plurality of magnetic rod devices is mounted upon the at least one frame member such that they extend into the interior of the vessel;

and wherein the vessel comprises an inlet configured to be arranged in fluid communication with a first fluid storage vessel and an outlet configured to be arranged in fluid communication with a second fluid storage vessel;

Embodiments of the fourth aspect of the invention may include one or more features of the first to third aspects of the invention or their embodiments, or vice versa.

According to a fifth aspect of the invention there is provided a magnetic apparatus suitable for use in an apparatus for removing ferrous particles from a liquid or slurry, the apparatus comprising:

a magnetic rod device comprising:
an elongate casing;
an elongate magnet assembly retractably mounted within said casing; and
a removal means on the exterior surface of the casing;

wherein each magnetic rod device has a first condition in which the elongate magnet assembly is positioned substantially below the removal means, and a second condition in which the elongate magnet assembly is positioned substantially above the removal means.

Embodiments of the fifth aspect of the invention may include one or more features of the first to fourth aspects of the invention or their embodiments, or vice versa

According to a sixth aspect of the invention, there is provided a storage facility comprising an apparatus for removing ferrous particles from a liquid or slurry according to the third or fourth aspects of the invention or its embodiments.

Embodiments of the sixth aspect of the invention may include one or more features of the first to fifth aspects of the invention or their embodiments, or vice versa.

According to a seventh aspect of the invention, there is provided a system comprising a storage facility and an apparatus for removing ferrous particles from a liquid or slurry according to the third or fourth aspects of the invention or its embodiments.

Embodiments of the seventh aspect of the invention may include one or more features of the first to sixth aspects of the invention or their embodiments, or vice versa

According to an eighth aspect of the invention, there is provided an oil and gas facility comprising an apparatus for removing ferrous particles from a liquid or slurry according to the first or second aspects of the invention or its embodiments.

Embodiments of the eighth aspect of the invention may include one or more features of the first to seventh aspects of the invention or their embodiments, or vice versa.

### BRIEF DESCRIPTION OF THE DRAWINGS

There will now be described, by way of example only, various embodiments of the invention with reference to the drawings, of which:

FIG. 1A is a perspective view of the magnetic separator apparatus, according to an embodiment of the invention;

FIGS. 1B, 1C and 1D are plan, inlet elevation and outlet elevation views respectively of the magnetic separator apparatus of FIG. 1A;

FIG. 2 is a side elevation view of the magnetic separator apparatus of FIG. 1A, with the side wall omitted to display the internals of the apparatus;

FIGS. 3A and 3B are schematic side views of two alternative configurations of a magnetic rod of the magnetic separator apparatus according to an embodiment of the invention;

FIG. 4 is an exploded, schematic view of the magnetic rod and frame attachment means of the magnetic separator apparatus of FIG. 1A;

FIGS. 5A and 5B are schematic views of two alternative configurations of the magnet assembly of a magnetic rod according to FIGS. 3A and 3B; and

FIG. 6 is a schematic representation of a liquid storage facility coupled to the magnetic separator apparatus of FIG. 1A.

### DETAILED DESCRIPTION OF PREFERRED EMBODIMENTS

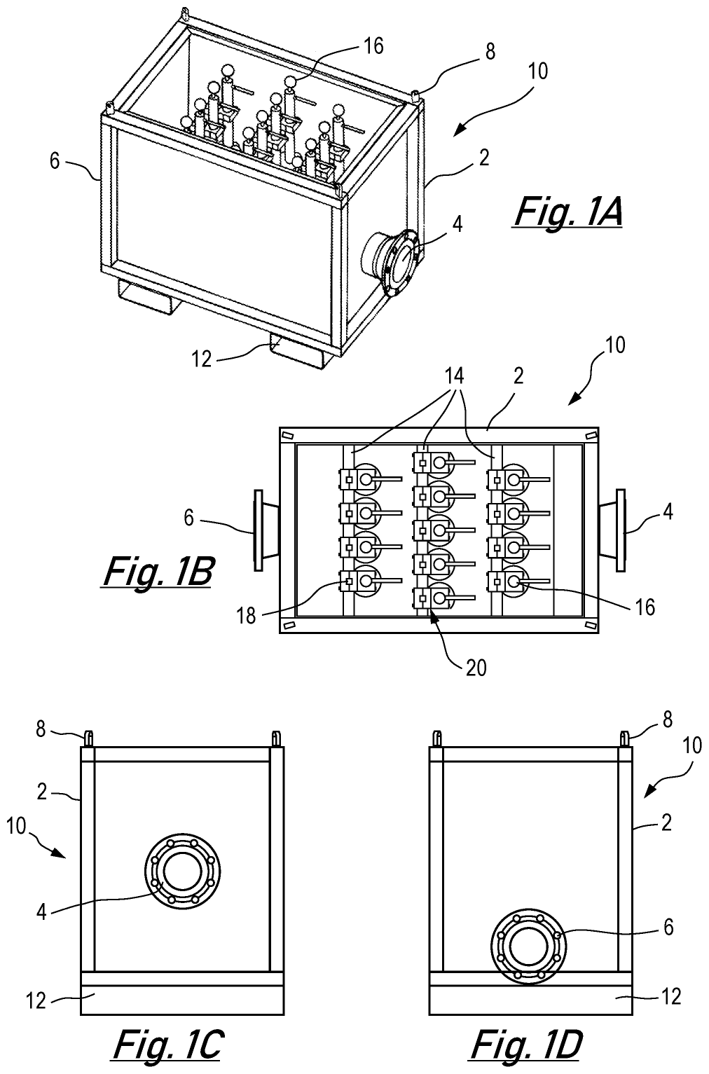

Referring firstly to FIGS. 1A to 1D, there is shown generally at 10 a magnetic separator apparatus according to a first embodiment of the invention. The apparatus comprises a vessel 2 with an inlet 4 and an outlet 6. To facilitate its transportation and installation, the vessel is fitted with lifting padeyes 8 and forklift pockets 12. Frame members 14 are secured to the vessel. Mounted upon frame members 14 by attachment means shown generally at 20 are a number of elongate magnetic rod devices 16 whose elongate body portions extend into the interior of the vessel. The magnetic rod devices 16 are arranged in offset rows defined by each frame member 14. Each attachment means 20 has a hole (not shown) which corresponds to a projection 18 on the frame member 14 for slotted attachment thereon. The inlet flange 4 is set at a higher position on the vessel than the outlet flange 6 to ensure efficient flow through and/or drainage.

FIG. 2 is a side view of the magnetic separator apparatus 10 with the side wall of the vessel removed such that the internal components can be seen more clearly. A baffle plate is 15 mounted proximate the inlet 4 of the vessel 2 such that it will contact incoming liquid or slurry, the general motion of which through the vessel is indicated by the arrows. The baffle plate will help to diffuse the flow of liquid or slurry from the inlet evenly across the width of the vessel, ensuring maximum exposure of the liquid or slurry to the magnetic fields produced by the magnetic rod devices therein. In addition, the baffle plate 15 will reduce the speed of the incoming liquid or slurry (again, increasing separation potential) and reduce the likelihood of splashing or spilling. The baffle plate shown in this embodiment is substantially rectangular, but it will be appreciated that different types of baffles, or none at all, may be used and mounted at different locations within the vessel.

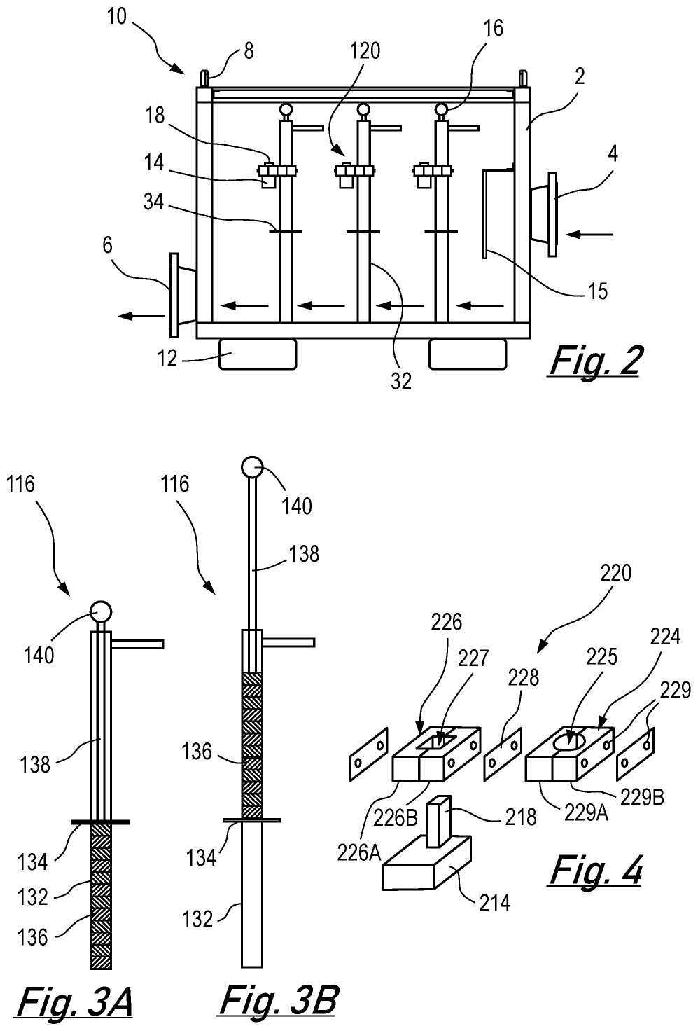

Each magnetic rod device 16 has an internal magnet assembly (not shown) which is slidably mounted within casing 32. Each rod 16 also has a removal means in the form of a plate shaped as an annular disc 34 secured to the outer surface of the casing 32. Each rod device can be configured in a first or a second condition. In the first condition, the internal magnet assembly (not shown) is positioned substantially below the removal plate 34 and in the second condition it is positioned substantially above the removal plate 34. A more detailed explanation of the configuration and constructional details of the magnetic rod devices is made below with reference to FIGS. 3A and 3B. Typically, when a liquid or a slurry is present in the vessel 2 the magnetic rod devices will be in their first condition such that the internal magnet assembly extends into the liquid or slurry, separated from it by casing 32.

Referring now to FIGS. 3A and 3B, it can be more clearly seen how a magnetic rod device is operated between its first and second conditions, respectively. The magnetic rod device 116 is the same as the magnetic rod device 16 of the previous figures, and will be understood from FIGS. 1A to 1D and 2 and the accompanying description, with like reference numerals incremented by 100. The casing 132 of each magnetic rod device 116 has been shown as transparent for clarity.

The magnet assembly 136 of the magnetic rod device 116 is made up of a number of smaller magnets, and mounted concentrically within casing 132. Attached to the upper end of magnet assembly 136 is a bar 138, at the upper end of which is a handle 140. The magnet assembly is moved up and down within the casing 132 by operation of the handle 140. The inner diameter surface of an annular removal plate 134 is secured concentrically to the outer surface of the casing 132.

The magnetic rod device 116 is shown in its first condition in FIG. 3A in which the magnet assembly 136 is positioned substantially below the removal plate 134. In operation, a liquid or slurry contaminated with ferrous particles is exposed to the magnetic rod device 116 while it is in its first condition, such that the ferrous particles which are present in the liquid or slurry are attracted to the casing 132 of the magnetic rod device 116 by magnet assembly 136, below removal plate 134.

The magnetic rod device 116 is then removed from the liquid or slurry, taking with it all of the ferrous particles which were present in the liquid or slurry, such that the liquid or slurry is no longer contaminated with such particles (i.e. it is clean). The handle 140 of the magnetic rod device 116 is then pulled upwards. As the handle 140 is pulled upwards, the magnet assembly 136 moves upwards within the casing 132. The magnetic field generated by magnet assembly 136 pulls the ferrous particles attracted to the outer surface of the casing 132 upwards also. When the magnetic rod device 116 arrives in its second condition, best shown in FIG. 3B, it can be seen that the magnet assembly 136 is positioned substantially above the removal plate 134. However, removal plate 134 stops the ferrous particles attracted to the outer surface of the casing 132 from moving up any further such that the magnetic field generated by magnet assembly 136 no longer attracts them. Therefore, the removal plate 134 acts as a removal means which removes the ferrous particles attracted to the outer surface of the casing 132 from the influence of the magnetic field produced by magnet assembly 136 as the magnetic rod 116 is moved in to its second condition, such that ferrous particles simply drop off of the magnetic rod device 116.

Referring now to FIG. 4 there is shown generally at 220 the attachment means used to mount a magnetic rod device (not shown) to a frame member 214 (a small portion of which is shown). Frame member 214 is the same as the frame member 14 of the previous figures, and will be understood from FIGS. 1A to 1D and 2 and the accompanying description, with like reference numerals incremented by 200.

The attachment means 220 generally consists of two main clamp bodies 224 and 226, which are each made up of two separable halves 224A, 224B and 226A, 226B, respectively, and each define aperture 225, 227 therein. The halves 224A, 224B of clamp body 224 are shaped as circular arches and define a circular aperture 225 when joined. The halves 226A, 226B of clamp body 226 are shaped as square arches and define a square aperture 223 when joined. Each clamp body 224, 226 also comprises a series of holes 229 which lined up with and correspond to holes 229 on plates 228 through which pins, bolts or screws (not shown) may be inserted to hold the two clamp bodies 224, 226 together.

The circular aperture 225 defined by clamp body 224 is sized correspondingly to the outer diameter of the casing of a magnetic rod device (not shown), such that when secured together the two halves 224A, 224B of clamp body 224 can clamp a magnetic rod device securely in place. The vertical position, or the extent to which a magnetic rod device extends into the vessel, can be adjusted easily by adjusting the axial position at which the clamp secures the casing of the rod device in place.

The frame member 214, upon which the magnetic rod devices are mounted, has a square projection located at each desired magnetic rod placement point. Only a small portion of the frame member 214 is shown in FIG. 4, upon which projection 218 can be seen. The square aperture 227 defined by clamp body 227 corresponds to the projection 218 on the frame member 214 for slotted attachment thereon. Hence, a magnetic rod device can be quickly and easily attached to or detached from a frame member, or a number of frame members.

In FIG. 4 the attachment means is shown to comprise a clamp body which defines an aperture which corresponds to projections on the frame members. However, it will be appreciated that in alternative embodiments of the invention the attachment means may vary. For example, a clamp may be provided which clamps on to the frame member itself, negating the requirement for the frame member to have projections, or the rod devices may be fixed to the frame members using bolts or screws.

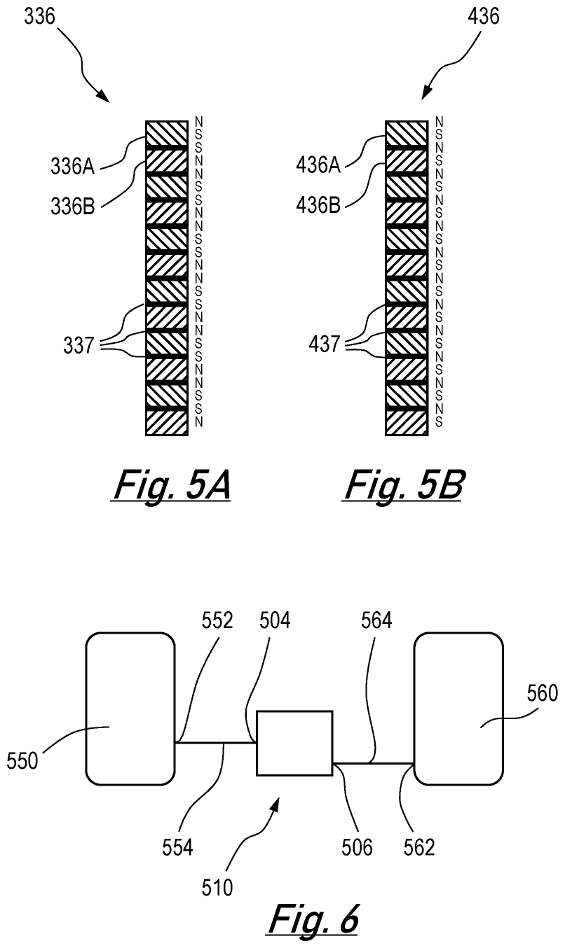

Referring now to FIGS. 5A and 5B, there is shown two alternative embodiments generally at 336 and 436, respectively, of how the smaller magnets which make up the magnet assembly of a magnetic rod device may be configured. Magnet assembly 336 and 436 are generally the same as the magnet assembly 36, 136 of the previous figures, and will be understood from FIGS. 1A to 1D, 2, 3A, 3B and the accompanying description.

The magnet assembly 336 of FIG. 5A shows each smaller magnet 336A, 336B and so on, arranged with repelling poles proximate to one another. For example, the south pole of magnet 336A lies adjacent to the south pole of magnet 336B. The magnet assembly 436 of FIG. 5B shows each smaller magnet 436A, 436B and so on, arranged with like poles proximate to one another. For example, the south pole of magnet 436A lies adjacent to the north pole of magnet 436B. In each case, the smaller magnets within the magnet assembly 336, 436 are separated by steel pole pieces 337, 437 respectively.

The magnet assembly of FIG. 5A will produce a further reaching magnetic field which is typically desirable in magnetic separation applications, however it will be appreciated that the magnets may also be configured as shown in FIG. 5B, or otherwise. It will also be appreciated that where more than one magnetic rod device is used within a magnetic separator apparatus, the magnet assembly of each rod may be configured differently.

It will be appreciated that although the configuration of the magnetic separator apparatus and its components has been described in the foregoing description, the magnetic separator apparatus and its components may be configured in a variety of alternative arrangements. For example, the inlet and the outlet of the vessel have been shown as flanged connections, in alternative embodiments of the invention the inlet and outlet ports may be provided with any other suitable standard connections and/or one or both may be provided with valves configured, for example, to control the inflow and/or outflow of fluid from the vessel. The vessel of the magnetic separator is shown without a lid, although it will be appreciated that in alternative embodiments a lid or other enclosure may be provided.

In the embodiment described in the foregoing description, three offset rows of magnetic rod devices are shown within the apparatus, mounted upon three frame members respectively. However, there may be any number of magnetic rod devices oriented at different heights, or with different spacing, with respect to one another, upon any number of frame members. The rows of magnetic rod devices may be aligned or offset with respect to one another, or a combination of the two. Likewise, the frame members may be mounted at alternative angles and at different vertical positions in the vessel. In addition, the individual frame members may be secured to one another to comprise one overall frame structure. The frame members, or the frame structure, may be secured to the vessel using screws, bolts, magnets, or any other suitable alternative attachment means. In some embodiments they may be welded for permanent attachment to the vessel. In alternative embodiments, the vessel itself may be a different size and shape with the inlet and the outlet, or multiple inlets and outlets, positioned at different locations.

Referring now to FIG. 6, there is provided an example application of the invention. The magnetic separator apparatus is the same as that in the previous figures, and will be understood from FIGS. 1A to 1D, 2 and the accompanying description, with like reference numerals incremented by 500.

In this embodiment, the magnetic separator apparatus 510 is used as a filter tank to clean a drilling fluid which has been contaminated with ultra-fine ferrous particles from an oil and gas process, and which has been stored in a storage facility for a period of time. The storage facility does not have a fluid ditch or open flowline. The magnetic separator apparatus 510 is fluidly coupled to a storage tank 550 containing a fluid contaminated with fine ferrous particles via a fluid conduit 554 connected between the outlet 552 of the storage tank 550 and the inlet 504 of the apparatus. The outlet side of the magnetic separator apparatus 510 is fluidly coupled to an empty storage tank 560 via a fluid conduit 564 connected between the outlet 506 of the apparatus 510 and the inlet 562 of the empty tank 560.

In operation, the contaminated fluid is flowed from storage tank 550 into the magnetic separator apparatus 510 by gravity, a pump or otherwise. As the contaminated fluid enters the apparatus 510 it encounters a baffle plate mounted proximate to the inlet 504. The baffle plate is beneficial as it slows the flow of fluid down and spreads it evenly throughout the vessel to ensure that all flow is subjected to the ferrous particle attracting magnetic fields produced by the magnetic rod devices mounted therein and that maximum separation is achieved. As the fluid flows through the apparatus 510 the magnetic rod devices (not shown) mounted within the vessel of the apparatus 510 by a number of frame members (not shown) are in their first condition such that the magnet assemblies of the magnetic rod devices are submerged in the fluid within their casings. As such, the fluid within the apparatus 510 is required to flow through the multitude of magnetic fields generated by the magnet assemblies of the rods. The specific configuration of the rods within the apparatus 510 is selected such that the magnetic fields extend across the entirety of the vessel, thus subjecting all, or the majority of, the fluid to the magnetic fields the ensure maximum separation of even ultra-fine ferrous particles.

As the fluid flows through the apparatus 510, the ferrous particles within it are attracted to the casings of the magnetic rod devices by the magnetic fields produced by the magnet assemblies mounted therein. Therefore, when fluid comes to exit the apparatus 510 via outlet 506, no contaminating ferrous particles remain present within it (i.e. the fluid is clean). The clean fluid is then flowed from the apparatus 510 to the empty storage tank 560 by gravity, a pump or otherwise for storage, disposal or re-use.

Throughout the cleaning process, or after the process has concluded, the magnetic separator apparatus itself may be cleaned to dispose of the collected ferrous particles. To do so, the magnetic rod devices are removed from the magnetic separator apparatus 510 to a discharge location. The rod devices may be individually removed from the frame members by simply lifting them off or, alternatively, the frame members themselves may be removed from the vessel of the apparatus to transport multiple magnetic rod devices at a time.

At the discharge location, the magnetic rod devices are moved to their second condition. The ferrous particles collected upon the casing of each magnetic rod device are removed from the influence of the magnetic field generated by the internal magnet assembly of each rod by the removal plates, such that they are no longer attracted to the magnetic rod device and simply fall away.

Beneficially, the magnetic separator apparatus has no moving parts whilst operating, which negates the requirement for electricity. An additional benefit of this is safety and a reduced risk of damage to the apparatus.

A further benefit of the magnetic separator apparatus is that it can be used in conjunction with systems in which typical magnetic separating apparatus would be unsuitable (i.e. systems which do not have a fluid ditch or an open flowline).

It should be appreciated that the magnetic separator apparatus may also be used in a variety of other contexts, where applicable, and that its application is not limited to use in a storage facility. The magnetic separator apparatus can also operate with a substantially stationary liquid or slurry inside, and is not limited to applications in which the liquid or slurry flows through it. In addition, the magnetic separator apparatus may be installed temporarily or permanently into a system, such as a pipeline, and provided with inlet and outlet connections suitable for its application.

The invention provides an apparatus for removing ferrous particles from metal contaminated oil and gas process liquids or slurries and method of use. The magnetic separator apparatus comprises a vessel with an inlet and an outlet configured to allow the flow through of a liquid or slurry, or to hold a liquid or slurry inside. A plurality of magnetic rod devices is mounted upon at least one frame member secured to the vessel such that they extend into the interior of the vessel. Each magnetic rod device has a first condition in which it is operable to attract ferrous particles, and a second condition in which it is operable to dispose of ferrous particles.

Embodiments of the invention provide a magnetic separator apparatus for removing ferrous particles from contaminated liquids and slurries which are stored in a storage facility.

Various modifications to the above-described embodiments may be made within the scope of the invention, and the invention extends to combinations of features other than those expressly claimed herein.

1. A method for removing ferrous particles from a liquid or slurry, the method comprising:
providing an apparatus comprising:
a vessel comprising an inlet and an outlet;
at least one frame member secured to the vessel; and
a plurality of magnetic rod devices mounted upon the at least one frame member such that the magnetic rod devices extend into the interior of the vessel, each magnetic rod device comprising an elongate casing, an elongate magnet assembly retractably mounted within said casing and an external removal means;
exposing the magnetic rod devices to a liquid or slurry contaminated with metal particles while the magnetic rod devices are in a first condition such that the magnet assemblies are positioned substantially below the removal means;
attracting metal particles to the casings of the magnetic rod devices;
removing at least one of the plurality of magnetic rod devices from the vessel; and
discharging magnetic particles from the at least one of the plurality of magnetic rod devices while it is in a second condition such that the magnet assembly is positioned substantially above the removal means.

2. (canceled)

3. The method according to claim 1, wherein the inlet and/or the outlet of the vessel are fluidly coupled to one or more flowlines, pipelines and/or storage tanks.

4. The method according to claim 1, comprising continuously or intermittently flowing a contaminated liquid or slurry through the vessel.

5. The method according to claim 1, comprising holding a body of substantially stationary contaminated liquid or slurry inside the vessel.

6. (canceled)

7. (canceled)

8. (canceled)

9. (canceled)

10. An apparatus for removing ferrous particles from a liquid or slurry, the apparatus comprising:
a vessel comprising an inlet and an outlet;
at least one frame member secured to the vessel; and
a plurality of magnetic rod devices, each magnetic rod device comprising:
an elongate casing;
an elongate magnet assembly retractably mounted within said casing; and
a removal means on the exterior surface of the casing;
wherein each magnetic rod device has a first condition in which the elongate magnet assembly is positioned substantially below the removal means, and a second condition in which the elongate magnet assembly is positioned substantially above the removal means; and
wherein the magnetic rod devices are mounted upon the at least one frame member such that they extend into the interior of the vessel.

11. The apparatus according to claim 10, wherein the inlet and/or the outlet of the vessel is provided with at least one valve.

12. The apparatus according to claim 10, comprising a baffle or a diffuser in the vessel.

13. The apparatus according to claim 10, wherein the at least one frame member is detachably secured to the vessel.

14. (canceled)

15. The apparatus according to claim 10, comprising a handle to facilitate the lifting and transportation of each of each of the plurality of magnetic rod devices.

16. The apparatus according to claim 10, wherein the removal means is in the form of an annular disc.

17. The apparatus according to claim 10, wherein the elongate magnet assembly of each of the plurality of magnetic rod devices comprises a plurality of magnets.

18. The apparatus according to claim 17, wherein the poles of the magnets are oriented axially with respect to the magnet assembly.

19. The apparatus according to claim 18, wherein the magnets are arranged with repelling poles proximate to one another.

20. (canceled)

21. The apparatus according to claim 10, wherein the least one frame member enables the plurality of magnetic rods to be mounted in a plurality of different positions laterally across the vessel.

22. The apparatus according to claim 10, wherein the least one frame member comprises a plurality of projections and wherein each of the plurality of magnetic rod devices is slotted on to a projection of the frame member.

23. (canceled)

24. The apparatus according to claim 10, wherein each of the plurality of magnetic rod devices is provided with an attachment means which enables the extent to which each of the plurality of magnetic rod devices vertically extends into the interior of the vessel to be adjusted.

25. A method of removing ferrous particles from a liquid or slurry from a storage facility, the method comprising:
providing an apparatus according to claim 10:
coupling the inlet of the vessel of the apparatus to a first fluid storage vessel containing a liquid or slurry contaminated with metal particles;
coupling the outlet of the vessel to a second fluid storage vessel;
flowing the liquid or slurry contaminated with metal particles from the first fluid storage vessel into the inlet of the apparatus;
attracting metal particles within the liquid or slurry to the magnetic devices of the apparatus; and
flowing the clean liquid or slurry from the outlet of the apparatus into the second fluid storage vessel.

26. (canceled)

27. (canceled)

28. (canceled)

29. An oil and gas exploration, production or storage facility comprising an apparatus for removing ferrous particles from a liquid or slurry according to claim 10 coupled to one or more flowlines, pipelines and/or storage tanks.

30. (canceled)

31. A system comprising a storage facility for oil and gas fluids or slurries and an apparatus for removing ferrous particles from a liquid or slurry according to claim 10.

32. The apparatus according to claim 12, comprising a baffle plate proximate the inlet of the vessel, operable to slow down and/or diffuse the flow of liquid or slurry from the inlet evenly across the vessel.
